(19) United States
(12) Patent Application Publication
(10) Pub. No.: US 2022/0044303 A1
(43) Pub. Date: Feb. 10, 2022

(54) GRAPHICAL USER INTERFACES FOR GENERATING A PURCHASE ORDER

(71) Applicant: DNOW L.P., Houston, TX (US)

(72) Inventors: Scott W. Hauck, Houston, TX (US); Sagar Desai, Houston, TX (US)

(21) Appl. No.: 17/388,508

(22) Filed: Jul. 29, 2021

Related U.S. Application Data
(60) Provisional application No. 63/062,248, filed on Aug. 6, 2020.

(51) Int. Cl. G06Q 30/06; G06Q 10/08

(52) U.S. Cl. CPC G06Q 30/0633; G06Q 30/0643; G06Q 10/0875

(57) ABSTRACT

A system and a method for generating a purchase order allow the ordering of commodities or other parts or items electronically. The system comprises a terminal, a means for providing a graphical user interface to a user, and a server communicatively to the terminal via a network. The system and the method are used for displaying a visual of all related parts of a piece of equipment or a table of functionally related items with different specifications. The system and the method can provide time savings in viewing, reviewing, adjusting quantities, and deleting in a purchase order large quantities of related parts or items.

### CROSS-REFERENCE TO RELATED APPLICATIONS

This application claims the benefit of priority to U.S. provisional application Ser. No. 63/062,248, filed on Aug. 6, 2020, which is incorporated herein by reference for all or any purposes.

### BACKGROUND

This disclosure relates generally to methods and systems for generating a purchase order, such as a purchase order of commodities. This disclosure relates more specifically to methods and systems that utilize a graphical user interface that expedites, at least in some circumstances, the ordering of a plurality of items.

In known graphical user interfaces that are configured for a purchaser to generate a purchase order, each item to be purchased is first located in the list of items for sale, a quantity of that particular item is then entered, and finally, the item and its quantity are added to an electronic shopping cart. At least the addition of the item and its quantity to the electronic shopping cart must be repeated for each item to be purchased.

For example, FIG. 1 illustrates a known graphical user interface 18 usable by a purchaser for generating a purchase order. In order to locate items to be purchased in the list of items for sale, the purchaser can display a subset of the list of items for sale. The subset is obtained by filtering the list of items for sale based on a category of items selected in a hierarchical structure 10, as well as in a filter 12 for selecting additional specifications, such as color, dimension, material, manufacturer, etc. Once the subset of the list of items for sale that is displayed on the graphical user interface contains one or more items to be purchased, the purchaser can enter a quantity for an item to be purchased into an editable field 14 specifically corresponding to the item. Then, the purchaser must add the item and its quantity to the electronic shopping cart by clicking on a button 16 corresponding specifically to the item and its quantity.

When purchasing commodities, it is not uncommon that the purchaser needs to order several dozens to a few hundred different items in a single purchase order, each possibly in a variable quantity. The repeated entering of the quantity and adding to the electronic shopping cart can be excessively time-consuming.

Thus, there is a continuing need in the art methods and systems for generating a purchase order.

### SUMMARY

The disclosure describes a method for generating a purchase order.

The method may comprise the step of transmitting a descriptor input by the user on the terminal to a server via a network.

The method may comprise the step of transmitting information indicative of the set of items stored on the server to the terminal, the set of items being associated with the descriptor. In some embodiments, the set of items may be determined from a hierarchical list associated with the descriptor. In some embodiments, the set of items may be determined from a bill of material of a product associated with the descriptor. In some embodiments, the set of items is determined from an electronic shopping cart previously generated and associated with the descriptor.

The method may comprise the step of displaying the information indicative of each of a set of items in a first arrangement on a graphical user interface of a terminal. In some embodiments, the first arrangement may include a table of cells, the table having at least one row and at least one column. In some embodiments, the first arrangement may include an exploded view of a product having parts. In some embodiments, the first arrangement may include an assembly view of a product having parts. In some embodiments, the information indicative of each of the set of items is a code uniquely associated with each of the set of items or a token indicative of the availability of each of the set of items for sale. In some embodiments, the information indicative of each of the set of items may be a picture uniquely associated with each of the parts of the product. In some embodiments, the information indicative of each of the set of items is a label uniquely associated with each of the parts of the product.

The method may comprise the step of identifying a first plurality of items in the set of items from a first area selected by a user within the first arrangement. In some embodiments, the first area may consist of one of a subset of contiguous cells in the at least one row, a subset of contiguous cells in the at least one column, or a block of contiguous cells in the table. In some embodiments, the first area includes a box.

The method may comprise the step of displaying a code uniquely associated with each of the first plurality of items in a bill of materials on the graphical user interface.

The method may comprise the step of identifying at least another item from the set of items.

The method may comprise the step of displaying information indicative of the at least another item in the bill of materials.

The method may comprise the step of identifying a second plurality of items in the first plurality of items from a second area selected by a user within the bill of materials.

The method may comprise the step of receiving a single number entered by the user on the terminal.

The method may comprise the step of comprising transferring all of the items displayed in the bill of materials to an electronic shopping cart automatically.

The method may comprise the step of generating a purchase order that includes all of the first plurality of items. The purchase order may further include the single number entered by the user as the ordered quantity of each of the second plurality of items.

The disclosure describes a system for generating a purchase order.

The system may comprise a means for providing the graphical user interface.

The system may comprise a server communicatively to a terminal via a network. The server may include a processor. The processor may be programmed for transmitting information indicative of a set of items stored on the server to a terminal, the set of items being associated with a descriptor. In some embodiments, the set of items may be determined from a hierarchical list associated with the descriptor. In some embodiments, the set of items may be determined from a bill of material of a product associated with the descriptor. In some embodiments, the set of items may be determined an electronic shopping cart previously generated and associated with the descriptor

The system may comprise the terminal, which includes a processor. The processor may be programmed for transmitting the descriptor input by the user on the terminal to the server via the network. The processor may be programmed for displaying the information indicative of each of the set of items in a first arrangement on a graphical user interface. In some embodiments, the first arrangement may include a table of cells, the table having at least one row and at least one column. In some embodiments, the first arrangement may include an exploded view of a product having parts. In some embodiments, the first arrangement includes an assembly view of a product having parts. In some embodiments, the information indicative of each of the set of items may be a code uniquely associated with each of the set of items or a token indicative of the availability of each of the set of items for sale. In some embodiments, the information indicative of each of the set of items may be a picture uniquely associated with each of the parts of the product. In some embodiments, the information indicative of each of the set of items may be a label uniquely associated with each of the parts of the product. The processor may be programmed for identifying a first plurality of items in the set of items from a first area selected by a user within the first arrangement. In some embodiments, the first area may consist of one of a subset of contiguous cells in the at least one row, a subset of contiguous cells in the at least one column, or a block of contiguous cells in the table. In some embodiments, the first area includes a box. The processor may be programmed for displaying a code uniquely associated with each of the first plurality of items in a bill of materials on the graphical user interface. The processor may be programmed for identifying at least another item from the set of items. The processor may be programmed for displaying information indicative of the at least another item in the bill of materials. The processor may be programmed for identifying a second plurality of items in the first plurality of items from a second area selected by a user within the bill of materials. The processor may be programmed for receiving a single number input by the user on the terminal. The processor may be programmed for transferring all of the items displayed in the bill of materials to an electronic shopping cart automatically. The processor may be programmed for generating a purchase order that includes all of the first plurality of items. The purchase order may further include the single number input by the user as the ordered quantity of each of the second plurality of items.

### BRIEF DESCRIPTION OF THE DRAWINGS

For a more detailed description of the embodiments of the disclosure, reference will now be made to the accompanying drawings, wherein:

FIG. 1 is a view of a known graphical user interface usable by a purchaser for generating a purchase order;

FIG. 2 is a view of a graphical user interface usable by a purchaser for generating a purchase order, the graphical user interface including a table;

FIG. 3 is a view of a graphical user interface usable by a purchaser for generating a purchase order, the graphical user interface including an exploded view;

FIG. 4 is a view of a graphical user interface usable by a purchaser for generating a purchase order, the graphical user interface including an assembly view;

FIG. 5 is a view of a graphical user interface usable by a purchaser for generating a purchase order, the graphical user interface including a table;

FIG. 6 is another view of the graphical user interface shown in FIG. 5;

FIG. 7 is a flow chart of a method for generating a purchase order;

FIG. 8 is a flow chart of a portion of the method shown in FIG. 7; and

FIG. 9 is a flow chart of another portion of the method shown in FIG. 7.

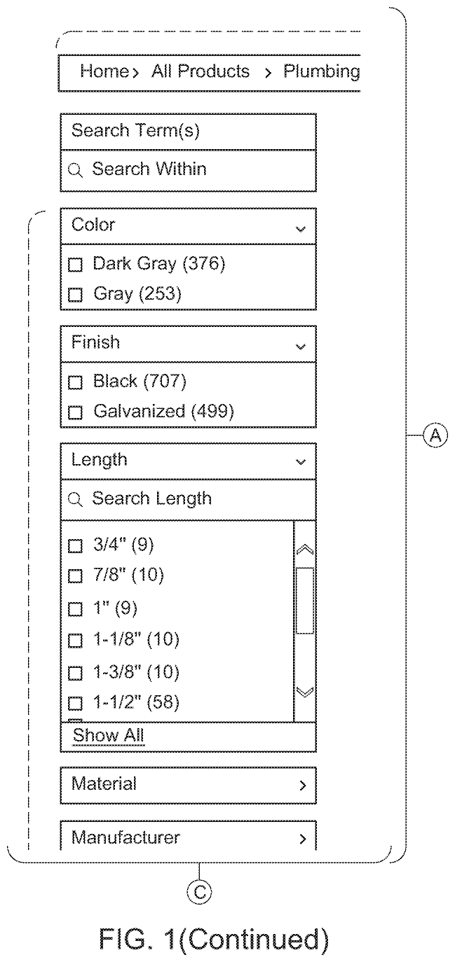

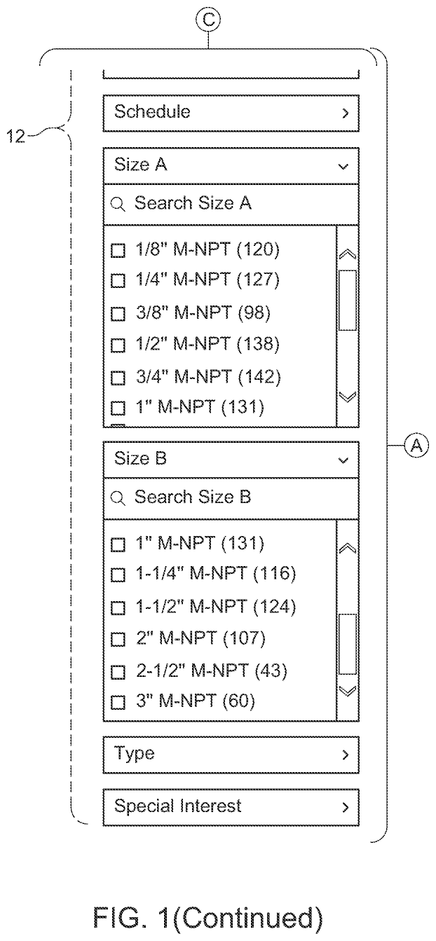

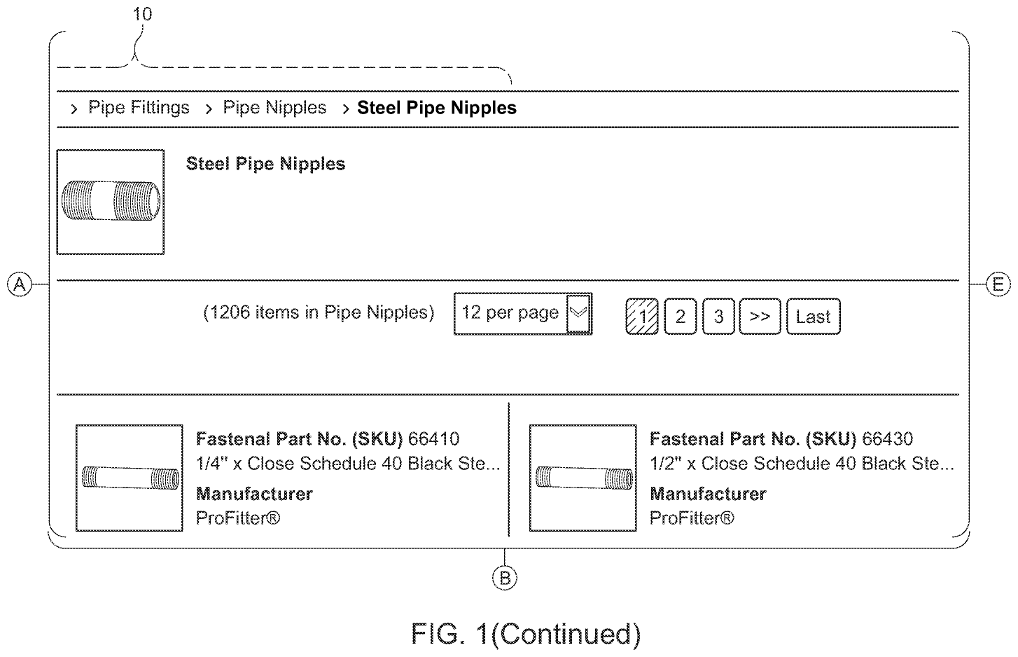

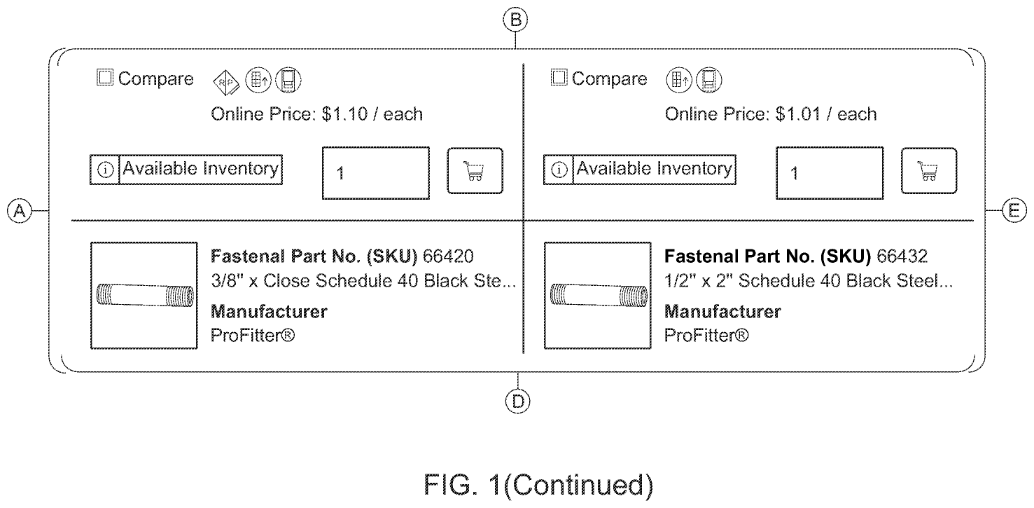

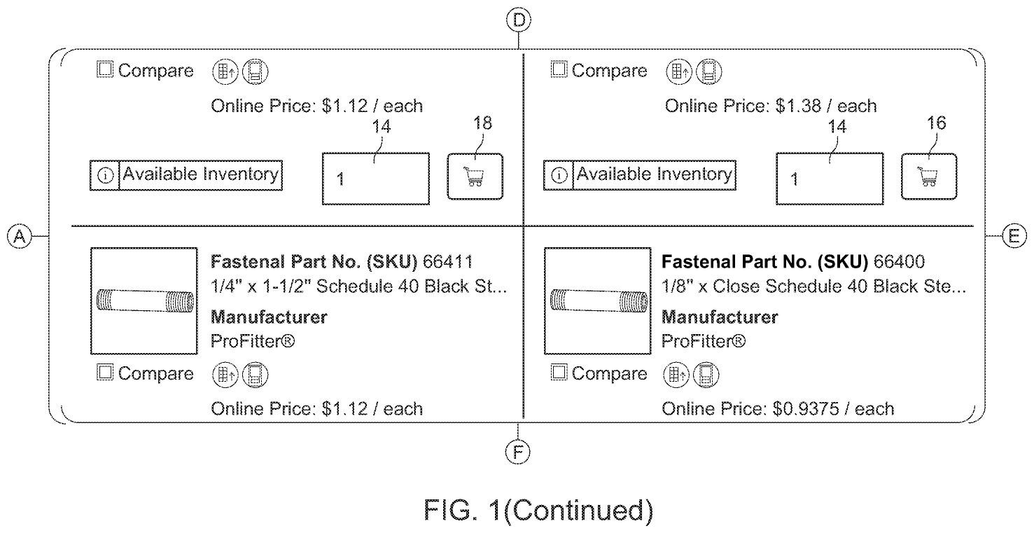

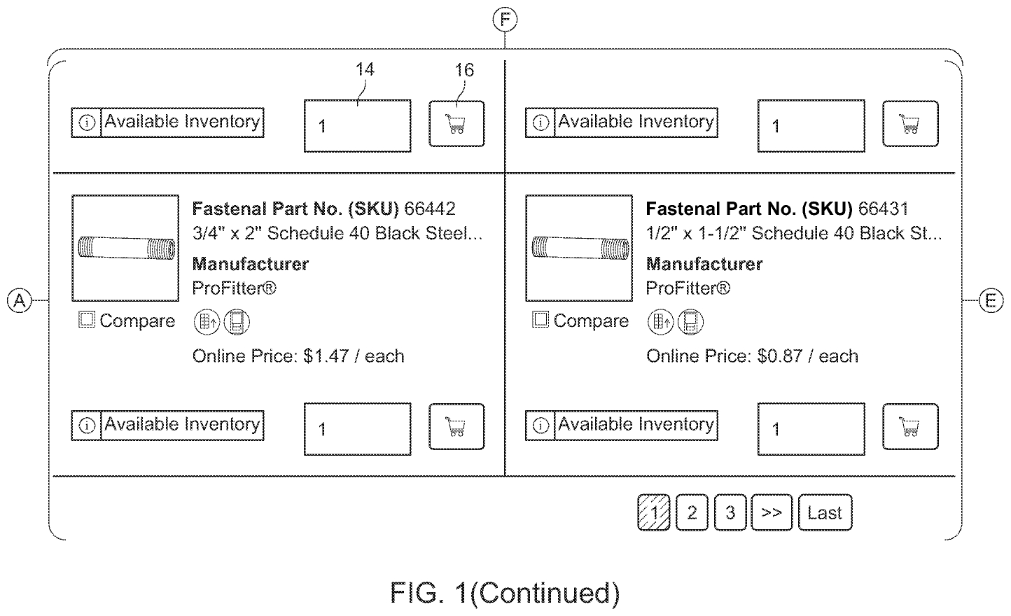

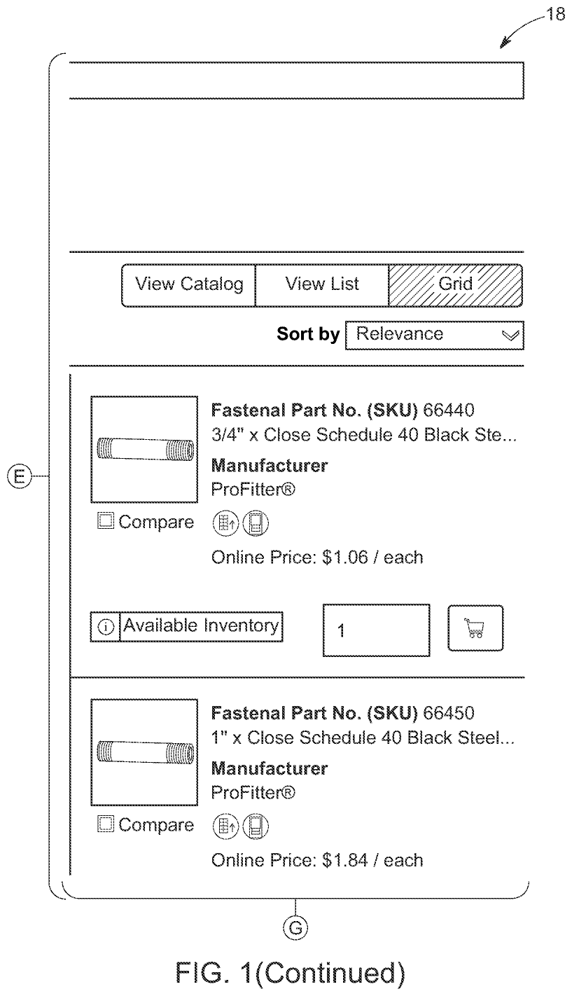

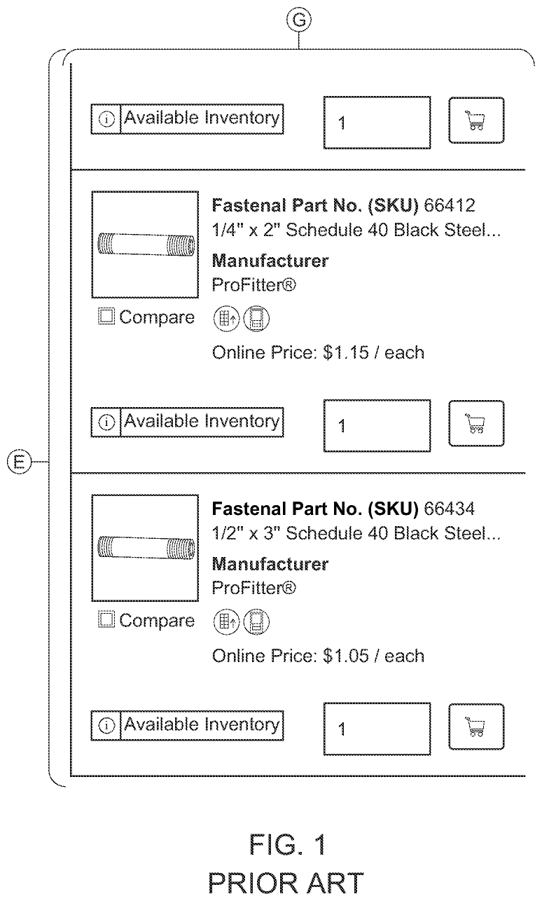

### DETAILED DESCRIPTION

It is to be understood that the disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Additionally, the exemplary embodiments presented below may be combined in any combination of ways, i.e., any element from one exemplary embodiment may be used in any other exemplary embodiment, without departing from the scope of the disclosure. Finally, all numerical values in this disclosure may be approximate values unless otherwise specifically stated. Accordingly, various embodiments of the disclosure may deviate from the numbers, values, ranges, and proportions disclosed herein or illustrated in the Figures without departing from the intended scope.

This disclosure describes a system and a method for generating a purchase order. The system and the method allow the ordering of commodities or other parts or items electronically. The system comprises a terminal (e.g., a desktop, laptop, tablet, smartphone), means for providing a graphical user interface to a user (e.g., a display, monitor, projector), and a server communicatively to the terminal via a network. The terminal and the server each include at least one processor. The processors are programmed for performing the method for generating the purchase order in cooperation with one another. The system and the method are preferably used when there is an advantage of displaying a visual of all related parts of a piece of equipment or a table of functionally related items with different specifications, such as dimensions (e.g., length, diameter), or material type. The system and the method utilize a graphical user interface that expedites, at least in some circumstances, the ordering of a plurality of items. The system and the method can provide time savings in viewing, reviewing, adjusting quantities, and deleting in a purchase order large quantities of related parts or items.

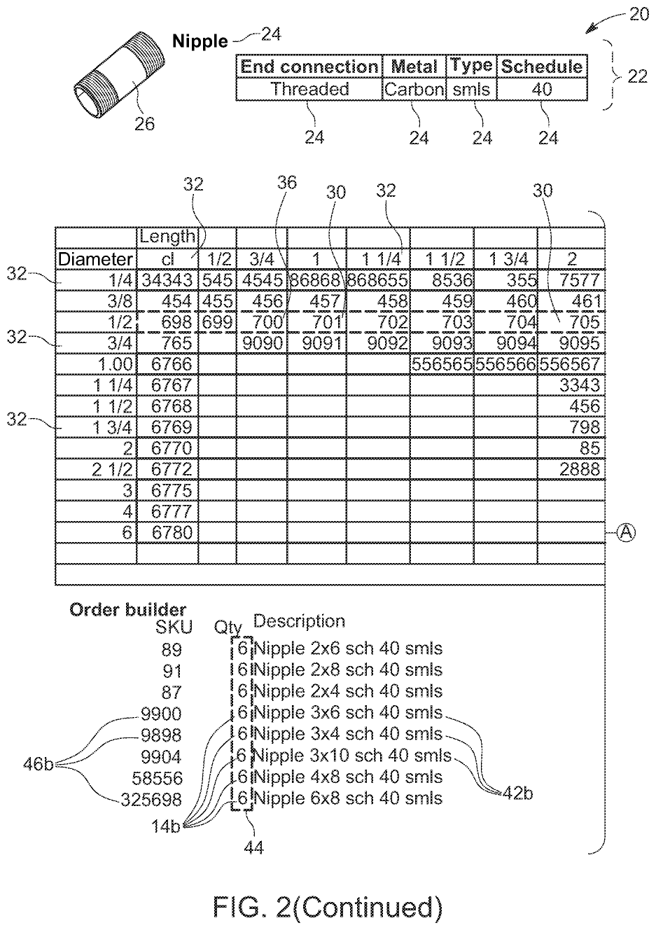

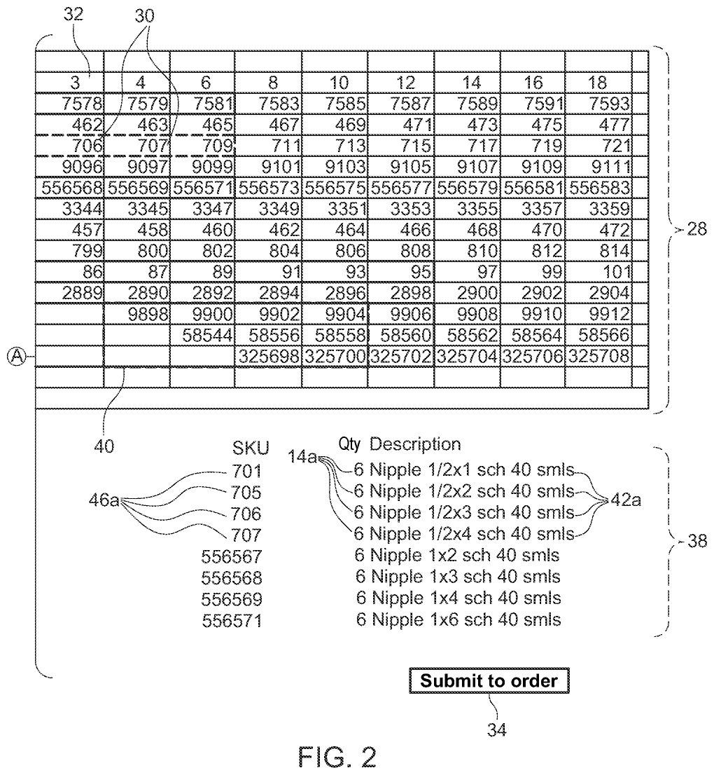

Referring to FIG. 2, a graphical user interface 20 usable by a purchaser for generating a purchase order is illustrated.

The graphical user interface 20 includes a filter-status portion 22. The filter-status portion 22 includes a display of one or more descriptors 24 that have been input by a purchaser on the terminal. For example, the descriptors may have been input by the purchaser by typing one or more keywords, by clicking on a hierarchical list, or by navigating back to the graphical user interface 20 after having saved an electronic shopping cart, or some combination of these actions. In addition, the one or more descriptors 24 can comprise values or ranges of values of additional specifications.

Optionally, the filter-status portion 22 includes a display of a visual 26 corresponding to the one or more descriptors 24 that have been input by the purchaser. The visual 26 is, for example, a picture, a photograph, or a graphic.

When performing the method for generating a purchase order in accordance with this disclosure, the one or more descriptors 24 are transmitted from the terminal to the server. The server holds a list of items for sale, which are stored on a memory of the server. The server determines a set of items associated with the one or more descriptors 24. For example, the set of items may be determined from a hierarchical list associated with one or more descriptors 24. Then, the server transmits information 30 indicative of each item of a set of items for sale to the terminal in response to the terminal transmitting the one or more descriptors 24. If applicable, the sever and/or the terminal may further filter the set of items for sale to keep the items for sale that have specifications in value ranges input on the terminal by the purchaser.

The graphical user interface 20 includes a set-of-items portion 28. The set-of-items portion 28 includes a display of the information 30 transmitted by the server. The display is organized in an arrangement. In the example shown in FIG. 2, the arrangement is a table that has a plurality of cells arranged in an array of one or more rows and one or more columns. The information 30 is a code that is displayed in one of the cells of the table. Note that some of the cells may not display information. The code is associated with a unique item that is for sale; for example, the code may be a stock-keeping unit (“SKU”). The set-of-items portion 28 also includes a display of additional item description 32, such as in row and column labels. In the example shown, the additional item description 32 corresponds to dimensions for each item of the set of items associated with the one or more descriptors 24. The dimensions may be displayed as numbers (e.g., “¼”) or abbreviations (e.g., “cl” standing for close).

When performing the method for generating a purchase order in accordance with this disclosure, the purchaser selects a first area 36 (illustrated as surrounded by a dashed line in FIG. 2) within the arrangement displayed in the set-of-items portion 28. As shown in FIG. 2, the first area 36 is a subset of contiguous cells in a row. However, the first area 36 may alternatively be a subset of contiguous cells in a column or a block of contiguous cells. The first area 36 is used to identify a first plurality of items as all the items that have the information 30 indicative thereof displayed in the first area 36. The identification can be triggered by purchaser actions such as the purchaser copying the content of the first area 36 in an electronic clipboard, the purchaser dragging the content of the first area 36 to a predetermined area on the graphical user interface 20, or any known single action. The process of selecting an area within the arrangement displayed in the set-of-items portion 28 can be repeated, such as with selecting an additional area 40 (also illustrated as surrounded by a dashed line in FIG. 2). The additional area 40 is similarly used to identify another plurality of items as all the items that have the information 30 indicative thereof displayed in the additional area 40.

The graphical user interface 20 includes an order-builder portion 38. The order-builder portion 38 includes a display of a code 46a,b uniquely associated with some or all of the first plurality of items identified from the first area 36, which, in the example of FIG. 2, is identical to the information 30 indicative of some or all of the first plurality of items identified from the first area 36. Again, the display is organized in an arrangement. In the example shown in FIG. 2, the arrangement is a bill of materials, which may span over one or more columns. Each entry on the bill of materials includes the code 46a (e.g., the SKU or an equivalent thereof) of one of the first plurality of items previously identified, an editable field 14a specifically corresponding to an order quantity of the same one of the first plurality of items, and a description 42a of the one of the first plurality of items. If applicable, the order-builder portion 38 also includes a display of the information indicative of some or all of the other plurality of items identified from the additional area 40, as well as the information indicative of other items previously identified from areas selected by the purchaser within the arrangement displayed in the set-of-items portion 28. For example, each entry on the bill of materials includes the code 46b (e.g., the SKU or an equivalent thereof) of one of the other plurality of items identified from the additional area 40, an editable field 14b specifically corresponding to an order quantity of the same one of the other plurality of items, and a description 42b of the one of the other plurality of items. Note that the order-builder portion 38 may not permanently include a display of the information indicative of all the items previously identified from areas selected by the purchaser within the arrangement displayed in the set-of-items portion 28. Indeed, when performing the method for generating a purchase order in accordance with this disclosure, the code 46a,b and description 42a,b of all the items previously identified from any area selected by the purchaser may initially be displayed in the order-builder portion 38; however, the purchaser may consecutively delete entries in the bill of materials.

When performing the method for generating a purchase order in accordance with this disclosure, the purchaser can select a second area 44 within the arrangement displayed in the order-builder portion 38. As shown in FIG. 2, the second area 44 (illustrated as surrounded by a dashed line in FIG. 2) is a subset of contiguous editable fields arranged in a column. However, the second area 44 may alternatively be any subset of editable fields. The second area 44 is used to identify a second plurality of items as all the items that have their editable fields displayed in the second area 44. The process of selecting an area within the arrangement displayed in the order-builder portion 38 can be repeated, such as with selecting an additional area. The additional area is similarly used to identify another plurality of items as all the items that have their editable fields displayed in the additional area. Then, the purchaser can input a number on the terminal, such as by typing, scrolling to, or clicking on the number. This number can be assigned to an order quantity for all of the second plurality of items, and if applicable, all of the other plurality of items identified from the additional areas selected by the purchaser within the arrangement displayed in the order-builder portion 38. For example, the assignment of the number can be triggered by the purchaser pasting or dragging the number.

The graphical user interface 20 includes a clickable button 34, for example, located next to the order-builder portion 38. When the button 34 is clicked by the purchaser, all of the items displayed in order-builder portion 38 are placed in an electronic shopping cart. As such, several items may be ordered at once, which may expedite the ordering.

A view of the content of the electronic shopping cart would show all items that have been placed in the electronic shopping cart. The view of the content of the electronic shopping cart may or may not allow the purchaser to edit the order quantity of at least some of the items placed in the electronic shopping cart. In contrast, the order-builder portion 38 displays, in a bill-of-material arrangement, the subset of items of the table displayed in set-of-items portion 28 that have been graphically identified by the purchaser. Also, the order-builder portion 38 allows the purchaser to conveniently edit the order quantity of at least some of the items that have been graphically identified by the purchaser.

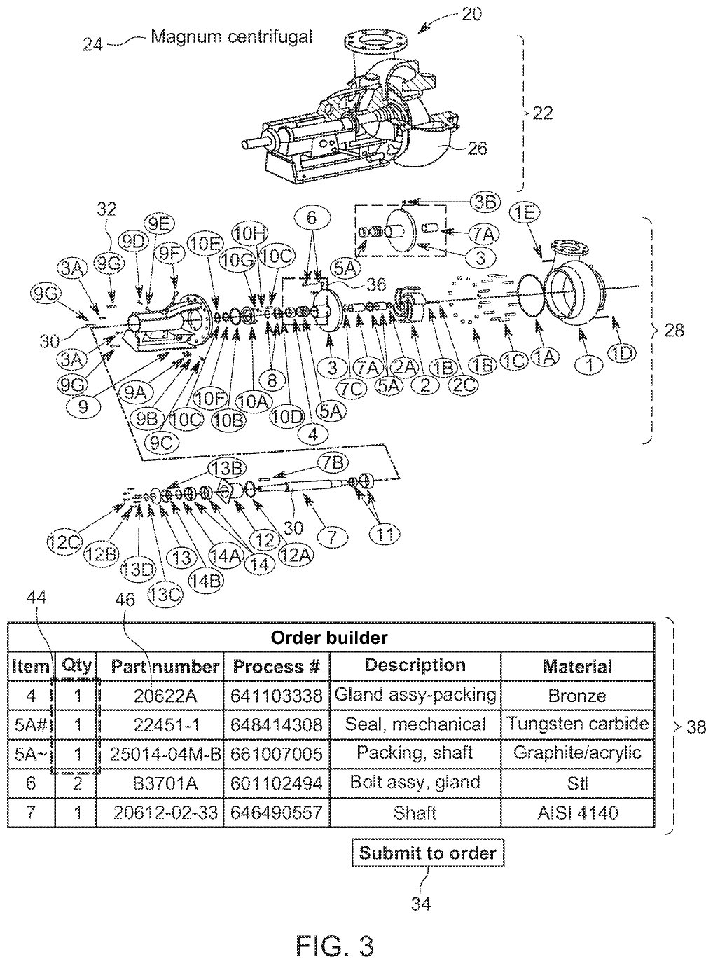

Referring to FIG. 3, another graphical user interface 20 usable by a purchaser for generating a purchase order is illustrated. The graphical user interface 20 shown in FIG. 3 shares several features with the graphical user interface 20 shown in FIG. 2. However, the graphical user interface 20 shown in FIG. 3 differs from the graphical user interface 20 shown in FIG. 2 at least in that the one or more descriptors 24 include a product name and/or a product manufacturer. The set of items associated with the one or more descriptors 24 is determined from a bill of material of a product associated with the one or more descriptors 24. The information 30 indicative of each part of the product corresponding to the one or more descriptors 24 is a picture uniquely associated with each of the parts of the product. The information 30 indicative of each part of the product is displayed in an exploded view arrangement. The additional item description 32 is a code associated with a unique part of the product. Optionally, a bill of material containing the code may be displayed, either on the graphical user interface 20 or on a pop-up window. The first area 36 that is used to identify the first plurality of items is a box.

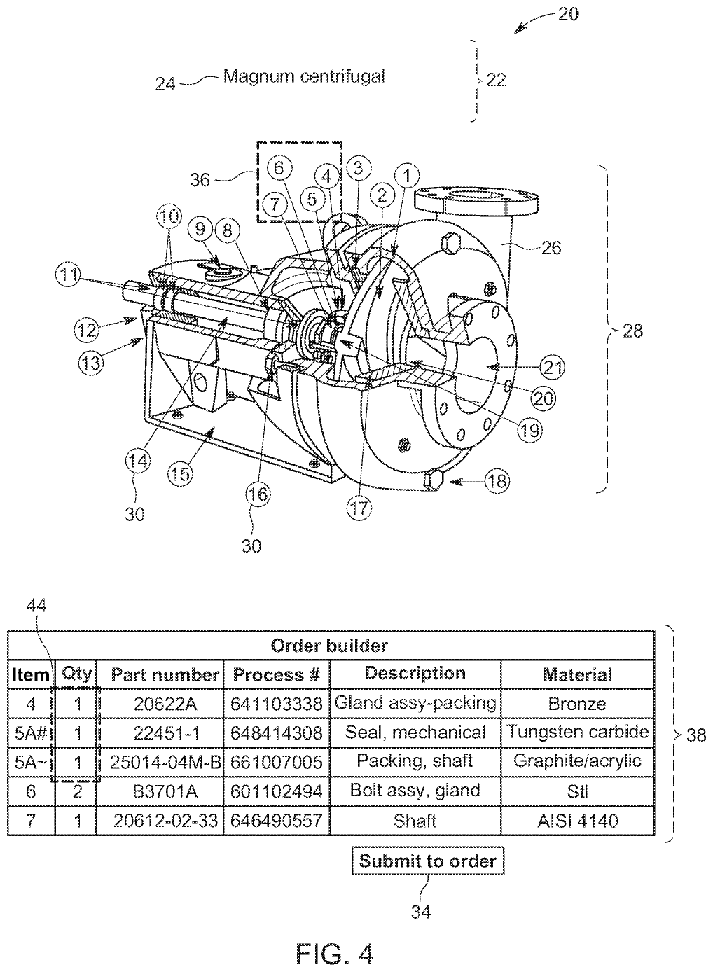

Referring to FIG. 4, yet another graphical user interface 20 usable by a purchaser for generating a purchase order is illustrated. The graphical user interface 20 shown in FIG. 4 shares several features with the graphical user interface 20 shown in FIG. 3. However, the graphical user interface 20 shown in FIG. 4 differs from the graphical user interface 20 shown in FIG. 3 at least in that the visual 26 corresponding to the one or more descriptors 24 is displayed in the set-of-items portion 28. The information 30 indicative of each part of the product corresponding to the one or more descriptors 24 is a label uniquely associated with each of the parts of the product with a lead line. The information 30 indicative of each part of the product is displayed in an assembly view arrangement.

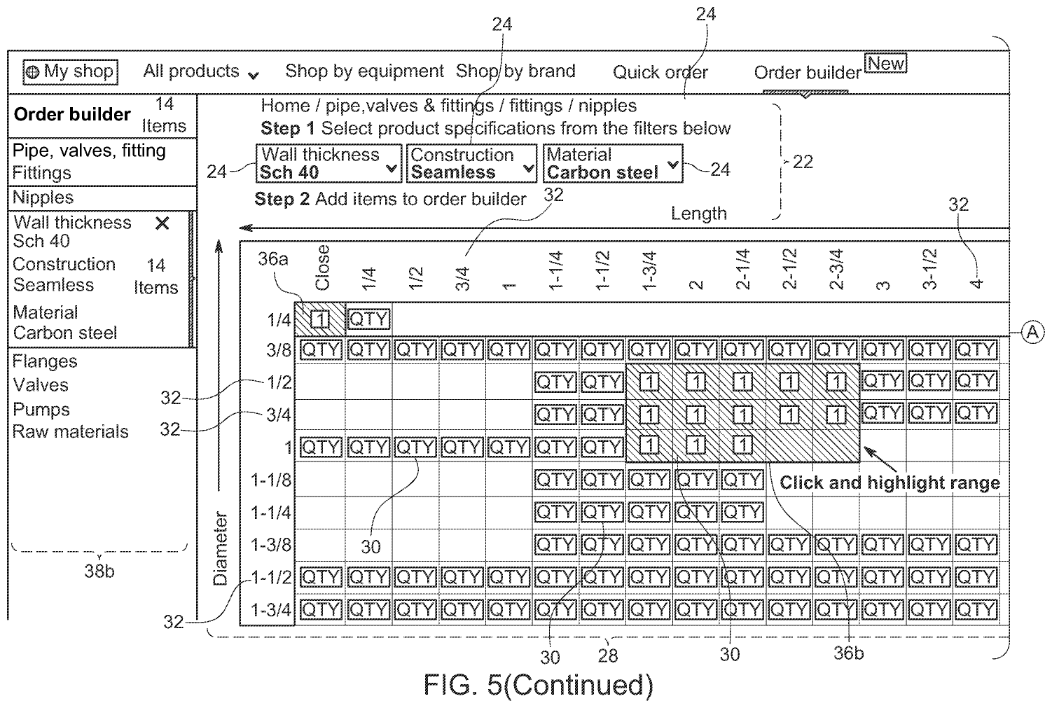

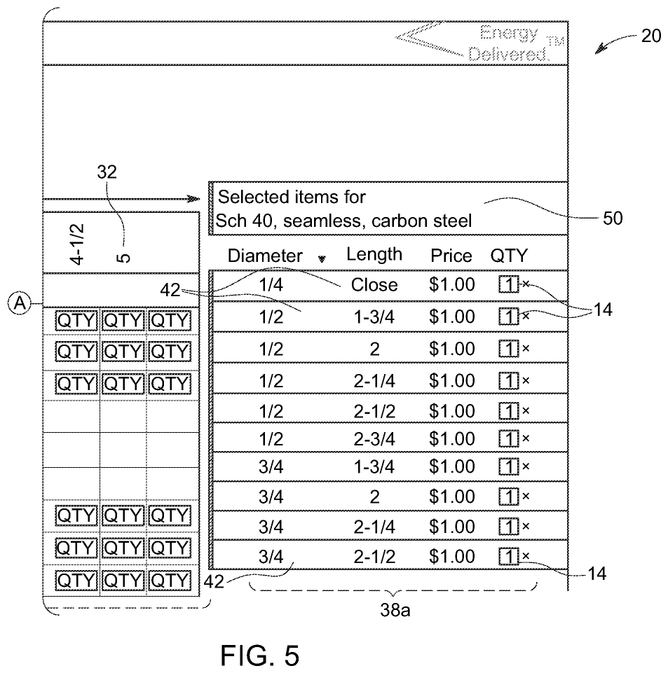

Referring to FIG. 5, another graphical user interface 20 usable by a purchaser for generating a purchase order is illustrated. The graphical user interface 20 shown in FIG. 5 shares several features with the graphical user interface 20 shown in FIG. 2. However, the graphical user interface 20 shown in FIG. 5 differs from the graphical user interface 20 shown in FIG. 2 at least in that the order-builder portion is split into two disjoint areas 38a, 38b (illustrated as hashed areas in FIG. 5).

The area 38a displays, in a bill-of-material arrangement, the subset of items of the table displayed in set-of-items portion 28 that are currently identified by the purchaser in the selected areas 36a and 36b. In the example shown, each entry on the bill of materials comprises a description 42 including the combination of additional descriptions 32 corresponding to one of the cells located within the selected areas 36a and 36b, as well as a price. Each entry on the bill of materials also comprises an editable field 14 corresponding to the same one of the cells located within the selected areas 36a and 36b. The editable field 14 contains an order quantity. Thus, the order-builder portion 38a allows the purchaser to conveniently edit the order quantity of at least some of the items that are currently identified by the purchaser in the selected areas 36a and 36b.

The area 38b displays, in a collapsible list arrangement, the subset of items of the table displayed in set-of-items portion 28 that have been graphically identified by the purchaser. In the example shown, the collapsible list groups together items that have the same descriptors 24, for example, the same category of a hierarchical structure and/or the same additional specifications of a filter.

Furthermore, the graphical user interface 20 shown in FIG. 5 differs from the graphical user interface 20 shown in FIG. 2 at least in that the button 34 may be omitted. In such a case, the portion of the electronic shopping cart that contains any of the items of the table displayed in set-of-items portion 28 may be automatically updated or synchronized with the order-builder portion displayed in areas 38a, 8b.

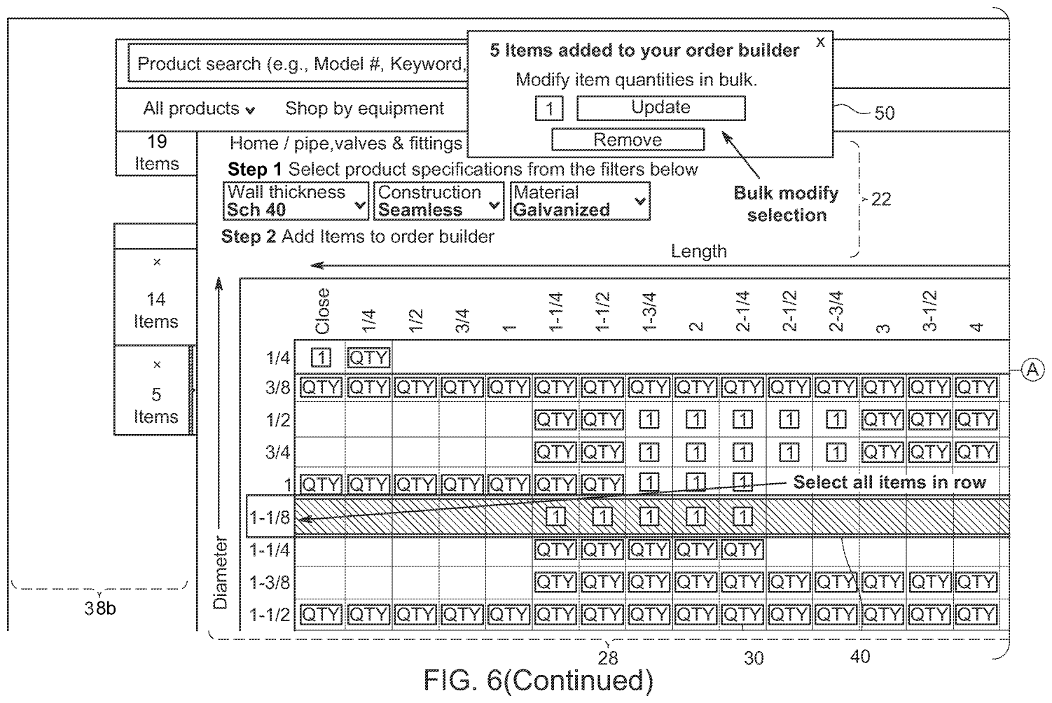

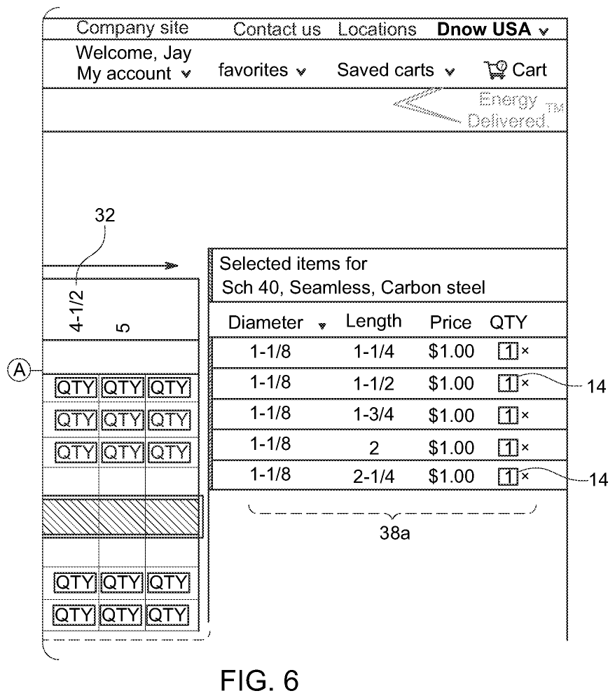

When performing the method for generating a purchase order in accordance with this disclosure, the purchaser can select the areas 36a, 36b. Then, the purchaser can modify the editable field 14 containing an order quantity for any entry on the bill of materials displayed in area 36a. When the selection is finished, a pop-up window 50, such as shown in FIG. 6, may automatically open. An action of the purchaser in this window causes the items listed in the areas 38a of the order-builder portion to be transferred to the area 38b of the order-builder portion, as is illustrated in FIG. 5. Alternatively, the items listed in the area 38a of the order-builder portion may be transferred to the area 38b of the order-builder portion upon clicking a button (not shown), or other action by the purchaser, the items listed in the areas 38a of the order-builder portion are transferred to the area 38b of the order-builder portion.

The graphical user interface 20 shown in FIG. 5 also differs from the graphical user interface 20 shown in FIG. 2 at least in that the information 30 indicative of each item of the set of items corresponding to the one or more descriptors 24 includes a token (e.g., a geometric shape such as a square) indicative of the availability of the item for sale. The token is displayed in only the cells of a table arrangement in the set-of-items portion 28 that correspond to combinations of additional descriptions 32 that are available for sale. The use of a token may be useful to conserve space in the graphical user interface 20 when the one or more descriptors 24 and the additional item description 32 unambivalently describe the items for sale. In addition, the token may optionally include an order quantity of each item that may also be displayed in the cells of a table arrangement in the set-of-items portion 28 Note that some of the cells in the set-of-items portion 28 may not display an order quantity, such as when the order quantity is zero.

Referring to FIG. 6, the graphical user interface 20 shown in FIG. 5 is illustrated when the purchaser selects an additional area 40.

When performing the method for generating a purchase order in accordance with this disclosure, the purchaser can select an additional area 40, which is a row of cells in the example shown in FIG. 6. The area 40 is used to identify a plurality of items as all the items that have the information 30 indicative thereof displayed in the area 40. The order quantities of the plurality of items that have been so identified are assigned a default value of one, and are displayed in area 38a of the order-builder portion. The order quantity displayed in each editable field 14 may be changed by the purchaser. When the selection of the additional area 40 is terminated, or when the purchaser clicks on a button (not shown), the items listed in the area 38a of the order-builder portion are added to the area 38b of the order-builder, a pop-up window 50 may ask the purchaser if all the order quantities that are in the editable fields 14 should be changed to another, purchaser-selectable value.

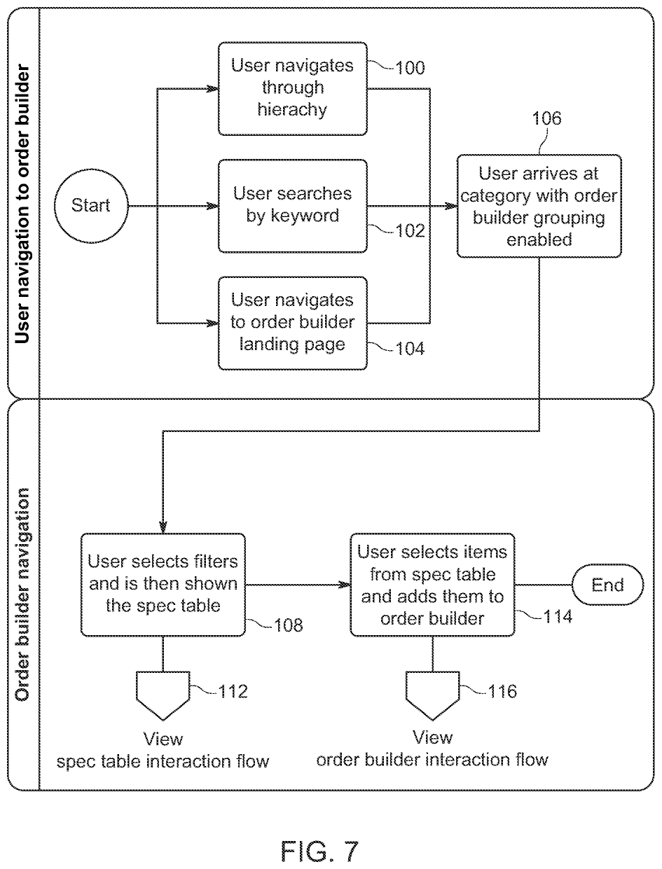

Referring to FIG. 7, a flowchart of a method for generating a purchase order is illustrated.

Using one or more of clicking on a hierarchical structure at step 100, inputting keywords at step 102, and returning to a web page to a graphical user interface 20 (in FIGS. 2-5) at step 104, the terminal shows the graphical user interface 20 to the purchaser at step 106. The graphical user interface 20 includes a filter-status portion 22 that allows the purchaser to further select a set of items at step 108. The information 30 indicative of each of a set of items in a first arrangement (e.g., a table) in a set-of-items portion 28 of the graphical user interface 20 at step 110. The purchaser can interact with the first arrangement at sub-method 112 in order to identify a plurality of items, or assign order quantities for each of the plurality of items. The plurality of items and the order quantities are displayed in a second arrangement (e.g., a bill of materials) in an order-builder portion 48 of the graphical user interface 20 at step 114. The second arrangement is used to generate a purchase order, such as via an electronic shopping cart. The purchaser can further interact with the electronic shopping cart before submission using the graphical user interface 20 at submethod 116.

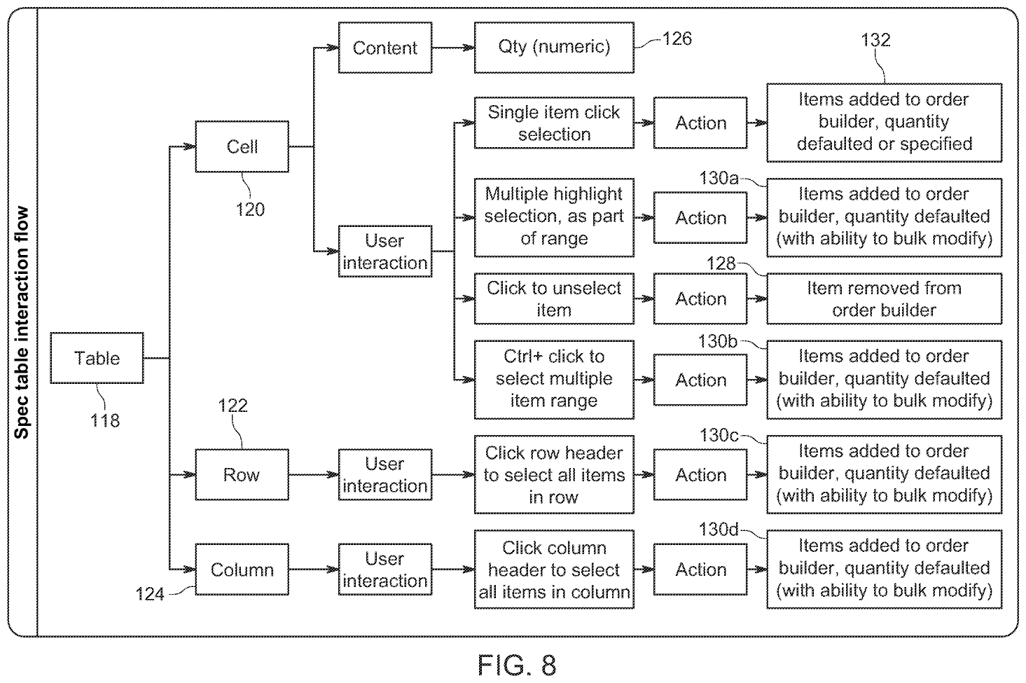

Referring to FIG. 8, a flowchart of an example sub-method 112 for interacting with a first arrangement in the form of a table 118 is illustrated. Information 30 indicative of each of the set of items (e.g., an ordering quantity) is displayed in some or all the cells of table 118 at step 126. The purchaser can interact with any of a graphically selected cell 120, a graphically selected row 122, or a graphically selected row 124 of table 118. The items of the table 118 that are identified from the graphical selection can be removed from the order-builder portion 48 at step 128. The items of the table 118 that are identified from the graphical selection can alternatively be added to the order-builder portion 48 at steps 130a, 130b, 130c, or 130d. An order quantity of the items in the order-builder portion 48 can be individually changed at step 132.

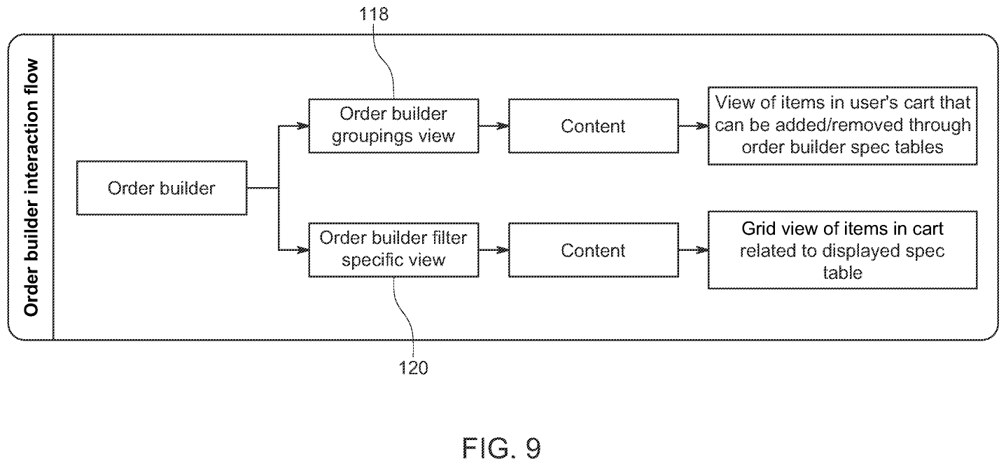

Referring to FIG. 9, a flowchart of an example sub-method 116 for interacting with an electronic shopping cart using the graphical user interface 20 (in FIGS. 2-5) is illustrated. Alternative selections methods (e.g., grouping from a hierarchical structure 118, or filtering using specification values or value ranges 120) can be used to view and modify a portion of the electronic shopping cart.

In this sub-method, the set of items for sale is stored in an electronic shopping cart previously generated and held in the server. When performing the method for generating a purchase order in accordance with this disclosure, the purchaser can select one or more descriptors 24. The server determines from the electronic shopping cart a set of items associated with the one or more descriptors 24. Then, the server transmits information 30 indicative of each item of the set to the terminal in response to the terminal transmitting the one or more descriptors 24.

The claimed invention is susceptible to various modifications and alternative forms, specific embodiments thereof are shown by way of example in the drawings and description. It should be understood, however, that the drawings and detailed description thereto are not intended to limit the claims to the particular form disclosed, but on the contrary, the intention is to cover all modifications, equivalents, and alternatives falling within the scope of the claims.

What is claimed is:

1. A method for generating a purchase order, comprising:
displaying information indicative of each of a set of items in a first arrangement on a graphical user interface of a terminal;
identifying a first plurality of items in the set of items from a first area selected by a user within the first arrangement; and
generating a purchase order that includes all of the first plurality of items.

2. The method of claim 1, further comprising displaying a code uniquely associated with each of the first plurality of items in a bill of materials on the graphical user interface.

3. The method of claim 2, further comprising:
identifying at least another item from the set of items; and
displaying information indicative of the at least another item in the bill of materials.

4. The method of claim 2, further comprising:
identifying a second plurality of items in the first plurality of items from a second area selected by a user within the bill of materials; and
receiving a single number entered by the user on the terminal;
wherein the purchase order further includes the single number entered by the user as the ordered quantity of each of the second plurality of items.

5. The method of claim 2, further comprising transferring all of the items displayed in the bill of materials to an electronic shopping cart automatically.

6. The method of claim 1,
wherein the first arrangement includes a table of cells, the table having at least one row and at least one column,
wherein the information indicative of each of the set of items is a code uniquely associated with each of the set of items or a token indicative of the availability of each of the set of items for sale, and
wherein the first area consists of one of a subset of contiguous cells in the at least one row, a subset of contiguous cells in the at least one column, or a block of contiguous cells in the table.

7. The method of claim 1,
wherein the first arrangement includes an exploded view of a product having parts,
wherein the information indicative of each of the set of items is a picture uniquely associated with each of the parts of the product, and
wherein the first area includes a box.

8. The method of claim 1,
wherein the first arrangement includes an assembly view of a product having parts,
wherein the information indicative of each of the set of items is a label uniquely associated with each of the parts of the product, and
wherein the first area includes a box.

9. The method of claim 1, further comprising:
transmitting a descriptor input by the user on the terminal to a server via a network; and
transmitting the information indicative of the set of items stored on the server to the terminal, the set of items being associated with the descriptor.

10. The method of claim 9, wherein the set of items is determined from a hierarchical list associated with the descriptor.

11. The method of claim 9, wherein the set of items is determined from a bill of material of a product associated with the descriptor.

12. The method of claim 9, wherein the set of items is determined from an electronic shopping cart previously generated and associated with the descriptor.

13. A system for generating a purchase order, comprising:
a terminal including a processor programmed for displaying information indicative of each of a set of items in a first arrangement on a graphical user interface, identifying a first plurality of items in the set of items from a first area selected by a user within the first arrangement, and generating a purchase order that includes all of the first plurality of items;
means for providing the graphical user interface; and
a server communicatively to the terminal via a network.

14. The system of claim 13, wherein the processor is further programmed for displaying a code uniquely associated with each of the first plurality of items in a bill of materials on the graphical user interface.

15. The system of claim 14, wherein the processor is further programmed for identifying at least another item from the set of items, and displaying information indicative of the at least another item in the bill of materials.

16. The system of claim 14,
wherein the processor is further programmed for identifying a second plurality of items in the first plurality of items from a second area selected by a user within the bill of materials, and receiving a single number input by the user on the terminal; and
wherein the purchase order further includes the single number input by the user as the ordered quantity of each of the second plurality of items.

17. The system of claim 14, wherein the processor is further programmed for transferring all of the items displayed in the bill of materials to an electronic shopping cart automatically.

18. The system of claim 13,
wherein the first arrangement includes a table of cells, the table having at least one row and at least one column,
wherein the information indicative of each of the set of items is a code uniquely associated with each of the set of items or a token indicative of the availability of each of the set of items for sale, and
wherein the first area consists of one of a subset of contiguous cells in the at least one row, a subset of contiguous cells in the at least one column, or a block of contiguous cells in the table.

19. The system of claim 13,
wherein the first arrangement includes an exploded view of a product having parts,
wherein the information indicative of each of the set of items is a picture uniquely associated with each of the parts of the product, and
wherein the first area includes a box.

20. The system of claim 13,
wherein the first arrangement includes an assembly view of a product having parts,
wherein the information indicative of each of the set of items is a label uniquely associated with each of the parts of the product, and
wherein the first area includes a box.

21. The system of claim 13,
wherein the processor is further programmed for transmitting a descriptor input by the user on the terminal to the server via the network, and
wherein the server includes a processor that is programmed for transmitting the information indicative of the set of items stored on the server to the terminal, the set of items being associated with the descriptor.

22. The system of claim 21, wherein the set of items is determined from a hierarchical list associated with the descriptor.

23. The system of claim 21, wherein the set of items is determined from a bill of material of a product associated with the descriptor.

24. The system of claim 21, wherein the set of items is determined an electronic shopping cart previously generated and associated with the descriptor.
